(19) United States
(12) Patent Application Publication
(10) Pub. No.: US 2026/0288039 A1
(43) Pub. Date: Sep. 24, 2026

(54) IMAGE FORMING APPARATUS

(71) Applicant: CANON KABUSHIKI KAISHA, Tokyo (JP)

(72) Inventor: HIROYUKI SEKI, Shizuoka (JP)

(21) Appl. No.: 19/410,221

(22) Filed: Dec. 5, 2025

(30) Foreign Application Priority Data
Jan. 30, 2025 (JP) 2025-014186

(51) Int. Cl. G03G 15/16; G03G 15/00

(52) U.S. Cl. CPC G03G 15/1695; G03G 15/6558; G03G 2215/00789

(57) ABSTRACT

An image forming apparatus includes an intermediate transfer belt, a transfer roller, registration roller pair, an accommodating tray, a manual feeding tray and an electrical discharging member. In a conveyance direction of a sheet, when a locus drawn by a leading end of the sheet is a conveyance passage in a case in which the sheet is nipped and fed in a contact portion formed by the registration roller pair after the leading end has passed through a feeding portion, and is nipped and fed in a transfer portion after the leading end has passed through the contact portion, the discharging member discharges the sheet in between the contact portion and the feeding portion in the conveyance passage, and is disposed in a side upstream of the contact portion and in a side downstream of a conveyance passage of the manual feeding tray and a double side conveyance passage.

### BACKGROUND

### Field of the Technology

The present invention relates to an image forming apparatus which applies an electrophotographic type, an electrostatic recording type, etc., and it relates to an image forming apparatus and an image forming system, which include an electrical discharging member in a sheet conveyance passage, for example.

### Description of the Related Art

Conventionally, an image forming apparatus of an electrophotographic type which is provided with an intermediate transfer member is known. In such an imaging apparatus, a primary transfer process, a secondary transfer process, and a fixing process are performed, and an image is formed on a recording material. The primary transfer process is a process in which a toner image which is formed on a photosensitive member is transferred onto the intermediate transfer member in a primary transfer portion. The secondary transfer process is a process in which the toner image of a plurality of colors which is formed on the intermediate transfer member by the primary transfer process which is performed in each primary transfer portion is collectively transferred onto the recording material in a secondary transfer portion. The fixing process is a process in which the unfixed toner image transferred in bulk is fixed onto the recording material.

Among conveying types for conveying the recording material to the secondary transfer portion, some are provided with a registration roller pair in upstream side of the secondary transfer portion with respect to a conveyance direction of the recording material in order to adjust a timing when the recording material enters the secondary transfer portion, for example. The registration roller pair conveys the recording material to the secondary transfer portion by nipping paper while rotating. The recording material may be charged due to feeding means and friction with the registration roller pair. When the recording material is conveyed to the secondary transfer portion while it is in a charged state, the toner image on the intermediate transfer member may not be transferred to the recording material or the toner image may be scattered. Accordingly, for example, in Japanese Laid-Open Patent Application (JP-A) 2013-050600, the electrical discharging member is disposed in non-contact with a peripheral surface of the registration roller. In this way, the charging of the registration roller is suppressed, and an accumulated charge is prevented from being transferred to the recording material. As another means to prevent the recording material, which is charged, from causing image defects in the secondary transfer portion, a method to apply a conveyance guide of the recording material between the registration roller and the secondary transfer portion has also been proposed. It is possible to prevent image defects, when the toner image on the intermediate transfer member is not disturbed by regulating the recording material with the conveyance guide so that the recording material which is charged is not too close to the intermediate transfer member and further the recording material which is charged is electrically discharged by grounding the conveyance guide in terms of an electrical potential.

However, in a configuration in which the electrical discharging member which is in non-contact with the peripheral surface of the registration roller is disposed, only electrically discharging the registration roller may not be sufficient, since an electric charge amount due to friction with the recording material whose resistance value is high and a feeding roller in a low-temperature and low-humidity environment may become large.

### SUMMARY

It is an object of the present invention to excellently transfer in a secondary transfer portion.

In response to the above issue, the present invention is provided with following configurations.

According to an aspect of the present invention, there is provided an image forming apparatus comprising: an image bearing member on which a toner image is formed; an intermediate transfer member on which the toner image formed on the image bearing member is transferred; a transfer roller configured to form a transfer portion in contact with a surface of the intermediate transfer member and to transfer the toner image transferred on the intermediate transfer member in the transfer portion onto a sheet; a first registration roller; a second registration roller configured to nip the sheet with the first registration roller and to convey the sheet to the transfer portion; a first accommodating portion configured to accommodate a sheet; a second accommodating portion configured to accommodate a sheet in state of being exposed outside the image forming apparatus; a feeding roller configured to form a feeding portion by contacting the sheet and feed the sheet from the first accommodating portion toward a contact portion formed by the first registration roller and the second registration roller in the feeding portion; and an electrical discharging member configured to electrically discharge the sheet which is electrically charged, wherein in a conveyance direction of the sheet, when a locus drawn by a leading end of the sheet is defined as a first conveyance passage in a case in the sheet is nipped and fed in the contact portion formed by the first registration roller and the second registration roller after the leading end of the sheet has passed through the feeding portion, and is nipped and fed in the transfer portion formed by the intermediate transfer member and the transfer roller after the leading end of the sheet has passed through the contact portion, a locus drawn by a leading end of the sheet is defined as a second conveyance passage in a case in which the sheet accommodated in the second accommodating portion is fed toward the first registration roller and the second registration roller, and a locus drawn by a leading end of the sheet is defined as a third conveyance passage in a case in which the sheet, of which a first surface on which image formation has been performed and a second surface, opposite to the first surface, on which the image formation is performed, is fed toward the first registration roller and the second registration roller, the electrical discharging member i) electrically discharges the sheet in between the contact portion and the feeding portion in the first conveyance passage, and ii) is disposed upstream side of the contact portion and downstream side of the second conveyance passage and the third conveyance passage in the conveyance direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of a laser printer engine according to a first embodiment and a second embodiment.

FIG. 2 is a control block diagram of a printer according to the first embodiment and the second embodiment.

FIG. 3 is a schematic diagram of a peripheral portion of registration rollers according to the first embodiment.

Part (a) and part (b) of FIG. 4 are schematic views showing an effect of an electrical discharging member according to the first embodiment.

FIG. 5 is a graph when measuring an electric charge amount on a sheet according to the first embodiment.

Part (a) and part (b) of FIG. 6 are schematic diagrams showing sticking positions of the electrical discharging member according to the first embodiment.

FIG. 7 is a schematic diagram of a peripheral portion of the registration rollers according to the second embodiment.

### DESCRIPTION OF THE EMBODIMENTS

### First Embodiment

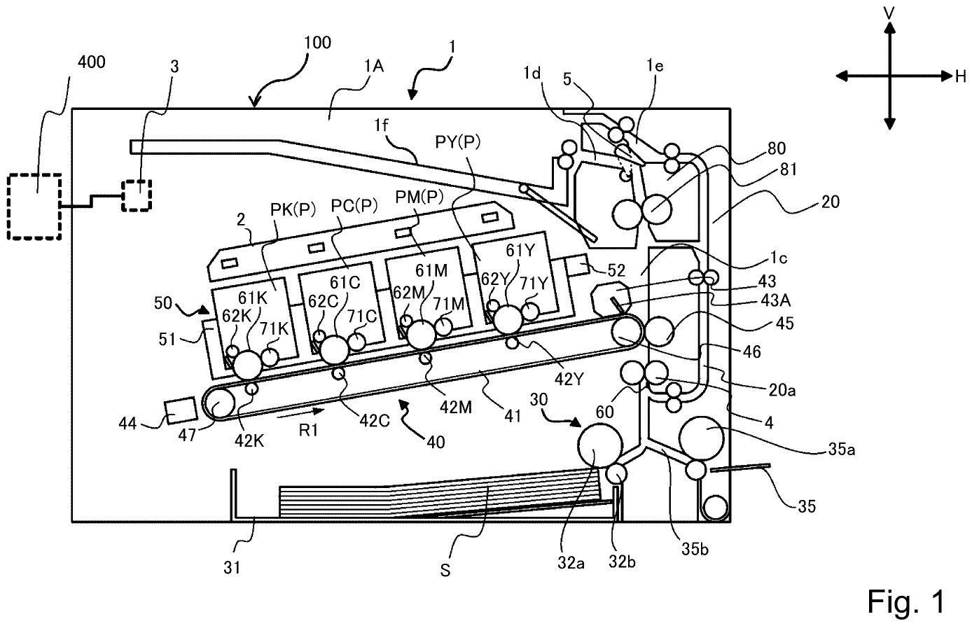

In the following, embodiments to which the present invention can be applied will be described. An overview of an overall configuration of a laser printer engine as an image forming apparatus will be described with reference to FIG. 1.

### Overview of Image Forming Apparatus

A printer 1 as an image forming apparatus will be described with reference to FIG. 1. FIG. 1 is a view illustrating an overall configuration of the printer 1 according to a first embodiment. The printer 1 is a color laser beam printer of an electrophotographic type which forms an image on a sheet S as a recording material. The printer 1 includes a main assembly (casing) 1A, a scanner (exposure device) 2, a control portion 3, and a door (opening/closing member) 20 which is capable of opening/closing with respect to a main assembly 1A. Furthermore, the printer 1 includes a feeding portion 30 as a feeding means, an intermediate transfer unit 40, a tray unit (moving unit, supporting unit) 50, and a fixing device 80. A portion which includes the main assembly 1A and the door 20 may also be referred to as a main frame 100. The main frame 100 includes an outer portion of the printer 1. The main assembly 1A accommodates a scanner 2, the control portion 3, the feeding portion 30, the intermediate transfer unit 40, a tray unit 50, and the fixing device 80. The feeding portion 30 includes a stacking tray 31 (first accommodating portion) as a stacking portion which stacks the sheet S, a pickup roller 32a (feeding roller), and a separating roller 32b. The stacking tray 31 is possible to be pulled out toward the door 20 to replenish the sheet S.

The tray unit 50 includes a tray (supporting member, drawer) 51, and the tray 51 includes a tray handle 52. Cartridges PY, PM, PC, and PK are removably mounted on the tray 51. The cartridges PY, PM, PC, and PK are independently dismountable from the tray 51. The cartridges PY, PM, PC, and PK accommodate toners (developers) of yellow (Y), magenta (M), cyan (C), and black (K), respectively. The cartridges PY, PM, PC, and PK are in the same configuration except for the colors of the toners which are accommodated. Therefore, in some cases, a configuration and an operation of one of the cartridges PY, PM, PC, and PK may be described, while the descriptions of the others may be omitted. Further, when it is not necessary to distinguish among the cartridges PY, PM, PC, and PK, the cartridges PY, PM, PC, and PK may be referred to simply as a cartridge P. The tray unit 50 may include the plurality of cartridges P and the tray 51 on which the plurality of cartridges P are removably mounted.

In the first embodiment, the tray unit 50 includes a plurality of photosensitive drums 61Y, 61M, 61C, and 61K (image bearing members), a plurality of charging rollers 62Y, 62M, 62C, and 62K (charging members), and a plurality of developing rollers 71Y, 71M, 71C, and 71K (developer carrying members). In regard to this, when it is not necessary to distinguish between Y, M, C, and K, there may also be some cases in which Y, M, C, and K are omitted. Specifically, the tray unit 50 includes four photosensitive drums 61, four charging rollers 62, and four developing rollers 71.

A portion which forms an image of the yellow (Y) is referred to as a yellow station (first station), the photosensitive drum 61Y of the first station is referred to as a first photosensitive drum, the developing roller 71Y is referred to as a first developing roller, and the charging roller 62Y is referred to as a first charging roller. In the same manner, a magenta station (second station) which forms an image of the magenta (M), a cyan station (third station) which forms an image of the cyan (C), and a black station (fourth station) which forms an image of the black (K) are disposed respectively with respect to a rotational driving direction of the intermediate transfer unit 40.

A PK cartridge is mounted on the black station, a PC cartridge is mounted on the cyan station, a PM cartridge is mounted on the magenta station, and a PY cartridge is mounted on the yellow station. In the first embodiment, the cartridge PK is referred to as a first cartridge, the cartridge PC is referred to as a second cartridge, the cartridge PM is referred to as a third cartridge, and the cartridge PY is referred to as a fourth cartridge. Incidentally, the numbers such as first, second, third, and fourth are conveniently used in descriptions. The photosensitive drum 61, the charging roller 62, and the developing roller 71 may be provided with either the cartridge P or the tray 51. In the first embodiment, the cartridge P includes the photosensitive drum 61, the charging roller 62, and the developing roller 71.

The intermediate transfer unit 40 includes an intermediate transfer belt (intermediate transfer member) 41, a primary transfer roller 42, a cleaning portion 43, a driving roller 46 which drives the intermediate transfer belt 41, and a tension roller (driven roller) 47. The intermediate transfer belt 41 moves in a moving direction R1 (counterclockwise direction in FIG. 1) by a driving force of the driving roller 46. In the printer 1, an optical sensor 44, which detects a toner image which is transferred onto the intermediate transfer belt 41, is disposed. The intermediate transfer belt 41 is disposed below the photosensitive drum 61 and is capable of contacting the photosensitive drum 61 so that a primary transfer portion is formed between the intermediate transfer belt 41 and the photosensitive drum 61. Further, the printer 1 includes a secondary transfer roller 45 (transfer roller) which contacts the intermediate transfer belt 41 so that a secondary transfer portion (transfer portion) is formed. The secondary transfer portion is formed between the intermediate transfer belt 41 and the secondary transfer roller 45. A direction of a rotational axis of the primary transfer roller 42, a direction of a rotational axis of the driving roller 46, a direction of a rotational axis of the tension roller 47, and a direction of a rotational axis of the secondary transfer roller 45 are parallel. On an upstream side of the secondary transfer portion (upstream with respect to a conveyance direction of the sheet S), a registration roller pair 4 (hereinafter referred to as a registration roller pair 4). The fixing device 80 includes a fixing portion 81 and a flapper 5. While an image forming operation is performed on the sheet S, the fixing device 80 is in an operating position. The fixing device 80 is accommodated in an inner part (inside) of the main assembly 1A while it is in the operating position. Further, the fixing device 80 is configured to heat the sheet S while it is in the operating position. The fixing portion 81 includes a heating portion (heating roller) which includes a heater and a pressing portion (pressing roller).

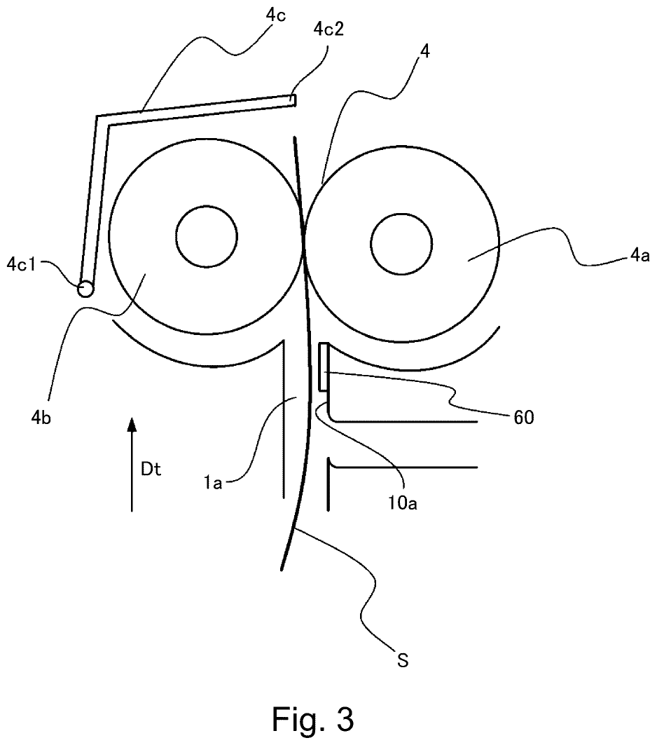

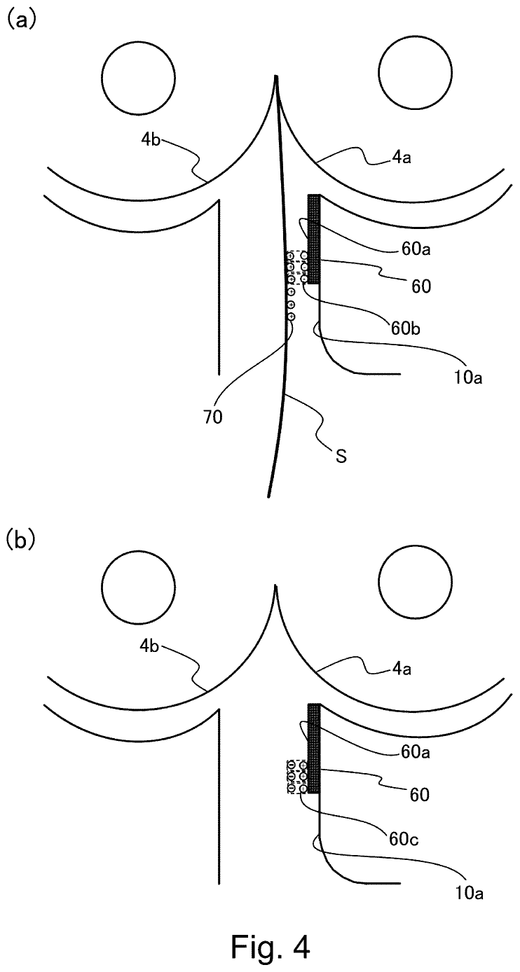

In the printer 1 according to the first embodiment, a sheet conveyance guide 10a (see FIG. 3) which guides the conveyance of the sheet S is provided upstream of the registration roller pair 4 in the conveyance direction of the sheet S. On the other hand, the sheet conveyance guide is not provided downstream of the registration roller pair 4 with respect to the conveyance direction of the sheet S, specifically in an area between the registration roller pair 4 and the secondary transfer portion. In this way, miniaturization of the printer 1 is realized.

The printer 1 is provided with a manual feed tray 35 as a second accommodating portion in which the sheet S is stacked while it is exposed to an outside portion with respect to the main assembly of the printer 1, in addition to the stacking tray 31 which is accommodated inside the printer 1. The sheet S which is stacked on the manual feed tray 35 is fed by a pickup roller 35a, conveyed in a conveyance passage 35b and reached to the registration roller pair 4. That is, the pickup roller 35a conveys the sheet S toward a contact portion of the registration roller pair 4. A locus which is drawn by a leading end of the sheet S while the sheet S is conveyed in the conveyance passage 35b is defined as a first conveyance passage. In the first embodiment, a distance between the secondary transfer portion (transfer portion) and the contact portion of the registration roller pair 4 in a conveyance passage 1c is shorter than a distance between the contact portion of the registration roller pair 4 and feeding portions in which pickup rollers 32a and 35a contact the sheet S.

### Image Forming Operation

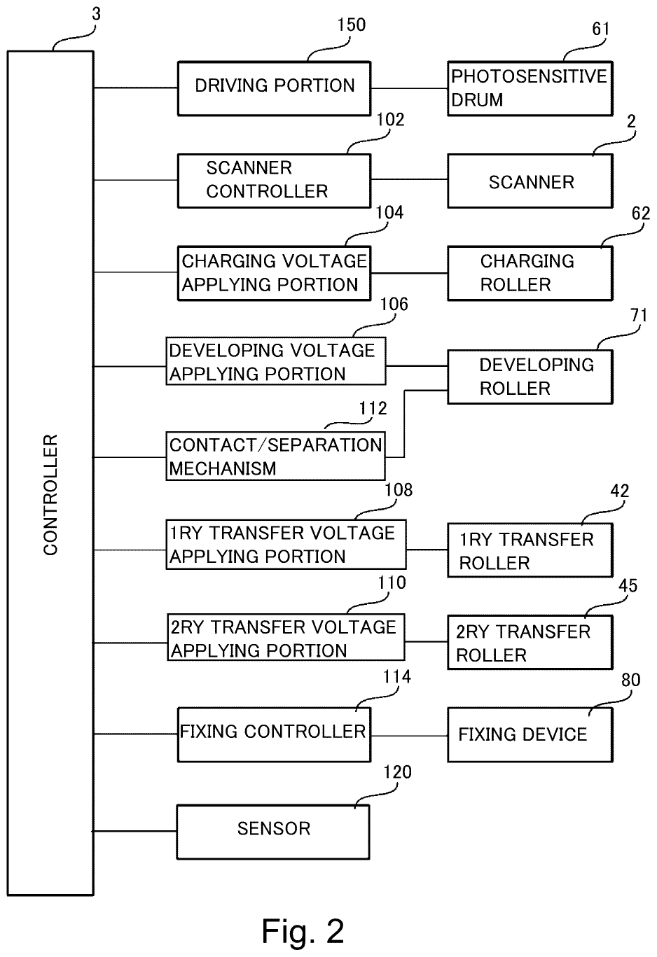

Image forming operations of the printer 1 will be described with reference to FIG. 1 and FIG. 2. FIG. 2 is the control block diagram of the printer 1. A horizontal direction H and a vertical direction V are also shown in FIG. 1. The control portion 3 of the printer 1 starts an image forming operation for the sheet S based on an image signal which is received from an external host device 400. The external host device 400 is, for example, a personal computer, an image reader, a fax machine, etc.

When image formation for the sheet S is performed, the fixing device 80 is positioned in the operating position, the tray unit 50 is positioned in a first inside position, the intermediate transfer unit 40 is positioned in a second inside position, and the door 20 is positioned in a closed position. When the intermediate transfer unit 40 is in the second inside position, the intermediate transfer belt 41 is capable of contacting the photosensitive drum 61. At this time, the tray unit 50 is positioned above the intermediate transfer unit 40.

A charging voltage is applied to the charging roller 62 by a charging voltage application portion 104, and the photosensitive drum 61 is rotated by a driving portion 150. A laser which corresponds to an image information is irradiated to the photosensitive drum 61 by a scanner control portion 102, and a surface of the photosensitive drum 61, which has been charged by the charging roller 62, is exposed. As a result, an electrostatic latent image which corresponds to the image information is formed on the surface of the photosensitive drum 61 (on an image bearing member). The developing roller 71 carries a toner. A developing voltage is applied to the developing roller 71 by a developing voltage application portion 106, the electrostatic latent image which has been formed on the photosensitive drum 61 is developed by the toner which is supplied from the developing roller 71, and a toner image is formed on the surface of the photosensitive drum 61. In the first embodiment, the developing roller 71 develops the electrostatic latent image while it is contacting the photosensitive drum 61, however, the developing roller 71 may also develop the electrostatic latent image while there is a gap between the developing roller 71 and the photosensitive drum 61. In a case that a full-color image is formed, a toner image of each color is formed on each photosensitive drum 61.

Incidentally, in the first embodiment, while the tray unit 50 is in the first inside position, the developing roller 71 is capable of moving between a contact position in which it contacts the photosensitive drum 61 and a separated position in which it is spaced away from the photosensitive drum 61. Specifically, a state in which the developing roller 71 is in the contact position and a state in which the developing roller 71 is in the separated position are switched by a contact/separation mechanism 112 which is a switching device which is provided with the main assembly 1A. As a result, in a state that image forming operation is not performed, it is possible to keep the developing roller 71 spaced away from the photosensitive drum 61.

Further, the printer 1 can perform monochrome printing, while the developing roller 71 which corresponds to the cartridge PK contacts the photosensitive drum 61, while the developing roller 71 which corresponds to each of the cartridges PY, PM, and PC is spaced away from the photosensitive drum 61. Further, the printer 1 can perform full-color printing, while the photosensitive drums 61 which correspond to the cartridges PY, PM, PC, and PK and the intermediate transfer belt 41. The toner image which is formed on each of the photosensitive drums 61 is transferred (primary transfer) onto the intermediate transfer belt 41 by the primary transfer roller 42 in the primary transfer portion and is conveyed toward the secondary transfer portion which is formed by the intermediate transfer belt 41 and the secondary transfer roller 45. During primary transfer, primary transfer voltage is applied to the primary transfer roller 42 by a primary transfer voltage application portion 108.

In the feeding portion 30, the pickup roller 32a contacts the sheet S and feeds the sheet S which is stacked on the stacking tray 31 at a predetermined timing. One piece of the sheet S is separated at a nip portion between the pickup roller 32a and the separating roller 32b, and conveyed through the conveyance passage 1c toward the secondary transfer portion and the fixing device 80. That is, the pickup roller 32a conveys the sheet S toward the contact portion of the registration roller pair 4. The conveyance passage 1c may also be described as a locus which is drawn by the leading end of the sheet S, in the case that the sheet S is nipped and conveyed in the contact potion of the registration roller pair 4 after passing through the feeding portion and the sheet S is nipped and conveyed in the secondary transfer portion after passing through the contact portion.

Incidentally, in FIG. 1, the pickup roller 32a performs both the feeding of the sheet S and the separation to convey only one piece of the sheet S in a case that the plurality of sheets S are fed, however, it is not limited to this. One roller may feed (pick up) the sheet S, while another roller may separate the sheet S by contacting the separating roller 32b. Further, a portion in which the pickup roller 32a contacts the sheet S is defined as the feeding portion, however, a nip portion between the pickup roller 32a and the separating roller 32b may also be defined as the feeding portion.

In the secondary transfer portion, the toner image on the intermediate transfer belt 41 is transferred to the sheet S (secondary transfer), when a secondary transfer voltage is applied to the secondary transfer roller 45 by a secondary transfer voltage application portion 110. On the other hand, the toner, which is not transferred to the sheet S, is removed from the intermediate transfer belt 41 by a cleaning blade (cleaning member) 43A which is provided in a cleaning portion 43 and collected into a waste toner collecting container (not shown). The sheet S, on which the toner image has been transferred in the secondary transfer portion, is conveyed toward the fixing device 80. The fixing device 80 is controlled by a fixing control portion 114, and the sheet S is heated and pressed in the fixing portion 81 and the toner image is fixed on the sheet S. The sheet S on which the toner image is fixed is conveyed toward the flapper 5 as a passage switching portion. The flapper 5 is capable of moving between a discharging position (solid line) which guides the sheet S which has passed through the fixing device 80 toward a discharging passage 1d, and a reversing position (dashed line) which guides the sheet S toward a reversing passage 1e.

In a case that single sided printing in which an image is formed on one side of the sheet S is performed, the sheet S is guided to the discharging passage 1d by the flapper 5 and discharged to a discharging tray 1f which is formed in an upper portion of the main assembly 1A. On the other hand, in a case that double sided printing, in which an image is printed on both a front side (first side) and a back side (second side, which is an opposite side to the first side) of the sheet S, the sheet S is guided by the flapper 5 to the reversing passage 1e. After the sheet S is guided to the reversing passage 1e, the conveyance direction of the sheet S is reversed, and the sheet S is conveyed toward the secondary transfer portion through a double-sided conveyance passage 20a which is formed in the door 20. A locus, which is drawn by the leading end of the sheet S while the sheet S is conveyed in the double-sided conveyance passage 20a, is defined as a second conveyance passage. After the toner image is transferred to the back side of the sheet S in the secondary transfer portion, the sheet S passes through the fixing device 80, is guided to the discharging passage 1d by the flapper 5, and is discharged to the discharging tray 1f of the main assembly 1A. The control portion 3 controls the driving portion 150, the scanner control portion 102, the charging voltage application portion 104, the developing voltage application portion 106, the primary transfer voltage application portion 108, the secondary transfer voltage application portion 110, the contact/separation mechanism 112, the fixing control portion 114, and a sensor 120.

### Configuration of Peripheral Portion of Registration Roller Pair

FIG. 3 is a schematic diagram showing the registration roller pair 4 which nips and conveys the sheet S, when it is viewed in a cross sectional direction. Here, the cross sectional direction is also a direction of a rotational axis of the registration roller pair 4. The registration roller pair 4 includes a registration roller 4a, a registration roller 4b, and a registration shutter 4c. The registration roller 4a (first registration roller) is configured of a medium electric resistance ethylene propylene rubber roller which is divided in a longitudinal direction. Incidentally, the registration roller 4a is electrically grounded via an aluminum core metal, so a surface of the registration roller 4a is prevented from being charged. On the other hand, a registration roller 4b (second registration roller) which is made of polyacetal resin is disposed in a position which is opposed to the registration roller 4a.

The registration shutter 4c is formed from aluminum sheet metal and is pressed by a spring (not shown). The registration shutter 4c includes a rotatable shaft 4c1 and a leading end portion 4c2. The registration shutter 4c is capable of rotating around the rotatable shaft 4c1. When the sheet S is conveyed from an upstream side with respect to a conveyance direction Dt, the leading end of the sheet S presses against the leading end portion 4c2 of the registration shutter 4c. The control portion 3 controls the sensor 120 such that a detection state and a non-detection state are changed according to an operation of the registration shutter 4c. That is, since a state of the sensor 120 is changed depending on a time when the leading end of the sheet S is pressing against the leading end portion 4c2 of the registration shutter 4c or not, the control portion 3 can determine whether or not the leading end of the sheet S has passed through the registration roller pair 4. For example, when the leading end of the sheet S pushes the leading end portion 4c2 of the registration shutter 4c and the sensor 120 becomes in the detection state, the control portion 3 determines that the sheet S has passed through the registration roller pair 4. For example, when the leading end of the sheet S does not press the leading end portion 4c2 of the registration shutter 4c (as shown in FIG. 3) and the sensor 120 remains in the non-detection state, the control portion 3 determines that the sheet S has not reached the registration roller pair 4. The control portion 3 controls so that the toner image on the intermediate transfer belt 41 is appropriately transferred to the sheet S according to a state when the sheet S reaches the registration shutter 4c.

An electrical discharging member 60 which electrically discharges the sheet S is provided in a side upstream of the registration roller pair 4 with respect to the conveyance direction Dt of the sheet S such that at least a portion of the electrical discharging member 60 is opposed to the sheet S. Further, the electrical discharging member 60 is disposed in a position that the sheet S, which is conveyed from the conveyance passage 35b of the sheet S which is fed from the manual feed tray 35 and the double-sided conveyance passage 20a, is discharged. In other words, the electrical discharging member 60 is positioned in a side upstream of the registration roller pair 4 and in a side downstream of the conveyance passage 35b and the double-sided conveyance passage 20a. Therefore, it is possible to discharge not only for the sheet S which is fed from the stacking tray 31, but also for the sheet S which corresponds to all image forming conditions, such as the sheet S which is conveyed from the manual feed tray 35 and the sheet S of the double-sided printing.

For example, in the first embodiment, the electrical discharging member 60 is stuck to the sheet conveyance guide 10a, which forms the conveyance passage 1a of the sheet S and guides the sheet S to the registration roller pair 4, and the electrical discharging member 60 is adhered with an adhesive member such as a double-sided tape. Here, the registration roller 4a is disposed on the same side as the secondary transfer roller 45 with respect to the conveyance passage 1c (right side in FIG. 1). The electrical discharging member 60 is disposed on a side of the registration roller 4a side (side of first registration roller) with respect to the conveyance passage 1c, or in other words, on a side of the secondary transfer roller 45. This is because, in order to correspond to all of the image forming conditions which are described above, it is possible to suppress image defects more effectively in a case that discharging is performed when it is on a closer side to the secondary transfer roller 45 in which the secondary transfer voltage is applied.

The electrical discharging member 60 is made of, for example, a nylon nonwoven fabric, which includes a plurality of fibers and whose electric resistance value is less than or equal to 1.0×10⁵ Ω under an environment of 23° C./50% in temperature (° C.) and humidity (%). The size of the electrical discharging member 60 is adjusted to a maximum sheet width that the printer 1 is possible to convey, so it is 300 mm in the longitudinal direction (direction of rotational axis) and 5 mm in the conveyance direction Dt, and it is electrically floating. A shortest distance between the sheet S and the electrical discharging member 60 while the sheet S is conveyed is approximately 5.0 mm.

### Effect of Electrical Discharging Member

An effect of the electrical discharging member 60 will be specifically described when an electrical discharging cloth is used as the electrical discharging member 60 in the first embodiment. When positive charges 70 are accumulated on the sheet S as shown in part (a) of FIG. 4, negative charges 60b are gathered in a leading end portion of the electrical discharging cloth as the electrical discharging member 60 (hereinafter simply referred to as electrical discharging cloth) which is mounted opposing to the sheet S. When the sheet S reaches a voltage which is higher than a predetermined value due to friction with the pickup roller 32a, a corona discharge occurs between the leading end portion 60a of a bristle tip of the electrical discharging cloth and the sheet S. When corona discharge occurs, gas molecules in the air are ionized and negative ions are generated. The generated negative ions combine with the positive charges 70 which are accumulated in the sheet S. As a result, the positive charges 70 on the sheet S which has passed through the electrical discharging cloth are reduced, that is, they are discharged. The electrical discharging cloth, which is mounted in electrically floating, is positively charged by discharging the sheet S. However, as shown in part (b) of FIG. 4, when the sheet S is not existed in an area which is opposed to the electrical discharging cloth until a following sheet S is fed and conveyed, positive charges 60c which has been accumulated are released by aerial discharging from a fibrous bristle tip (leading end portion 60a of bristle tip), and a potential of the electrical discharging cloth is attenuated. Therefore, it is possible to continuously exhibit a discharging effect sufficiently even during continuous printing.

In order to achieve such a discharging effect, a distance between the sheet S and the electrical discharging cloth is important. In a case that the distance between the sheet S and the electrical discharging cloth is too long, an amount of corona discharge generation is reduced and it is not possible to supply sufficient amount of the negative ions. As a result, the sheet S is not possible to obtain sufficient discharging effect, and an abnormal discharging image may be occurred. An appropriate distance is measured and established by conducting experiments which will be described below.

### Experiment 1 for Effect of Electrical Discharging Member, Comparison of Frequency of Occurrence of Abnormal Image

An experiment on an effect of the electrical discharging member 60 according to the first embodiment is conducted by using the printer 1. In the experiment, a frequency of an occurrence of an abnormal image is measured when 100 consecutive sheets of magenta halftone image formation is performed by setting the sheet S on the stacking tray 31. Further, in the experiment, a frequency of an abnormal image occurrence is measured by changing the distance between the electrical discharging cloth (electrical discharging member 60) which is disposed on the sheet conveyance guide 10a and the sheet S. High white paper GFC081 (Canon Marketing Japan Inc.) is used as the sheet S, and the experiment is conducted under an environment of low temperature and low humidity that is 15° C. in temperature and 10% in relative humidity. The high white paper GFC081 which is used in the experiment is left in low temperature and low humidity for 2 days and for 10 days. The frequency of the occurrence on each sheet S is measured by using the sheet S which is left in a low-temperature and low-humidity environment for 2 days assuming that a user uses under a general condition, and the sheet S which is left in the low-temperature and low-humidity environment for 10 days assuming that a user uses under a more severe condition. A experiment is also conducted in a case that the electrical discharging cloth is not mounted as a comparative example. The results are shown in Table 1. Table 1 shows comparative examples and each embodiments in a first column, configurations with and without the electrical discharging cloth in a second column distances between the electrical discharging cloth and the sheet S in a third column, experimental results in a case that the sheet S has been left for 2 days in a fourth column, and experimental results in a case that the sheet S has been left for 10 days in a fifth column.

TABLE 1

| | Electrical | | | |
|---|---|---|---|---|
| | discharging | Distance | Left for | Left for |
| | cloth | to sheet | 2 days | 10 days |
| Comparative example | NO | — | 10 sheets | 20 |
| sheets | | | | |
| First embodiment | YES | 0 mm | 5 sheets | 7 sheets |
| Second embodiment | YES | 5.1 mm | 2 sheets | 7 sheets |
| Third embodiment | YES | 5.0 mm | no occur | |
| 5 sheets | | | | |
| Third embodiment | YES | 4.0 mm | no occur | 5 sheets |
| Modified example 1 | | | | |
| Third embodiment | YES | 3.0 mm | no occur | 4 sheets |
| Modified example 2 | | | | |
| Third embodiment | YES | 1.9 mm | no occur | |
| 2 sheets | | | | |
| Modified example 3 | YES | 1.8 mm | no occur | |
| Third embodiment | | | | |
| no occur | | | | |
| Modified example 4 | | | | |

### Comparative Example

In a comparative example, an experiment is conducted while the electrical discharging cloth is not mounted. In the comparative example, an abnormal discharging image which seems that a portion of magenta halftone image is missing (hereinafter, simply referred to as an abnormal discharging image). Specifically, the abnormal discharging image is occurred at a frequency of 10 out of 100 sheets in a case of the sheet S which has been left for two days, and the abnormal discharging image is occurred at a higher frequency of 20 out of 100 sheets in a case of the sheet S which has been left for ten days.

### First Embodiment

In the first embodiment, an experiment is conducted while the distance between the electrical discharging cloth and the sheet S is set to be 0 mm, that is, the sheet S is in contact with the electrical discharging cloth. In the case of the first embodiment, the abnormal discharging image is occurred at a frequency of 5 out of 100 sheets in a case that the sheet S has been left for two days, and the abnormal discharging image is occurred at a frequency of 7 out of 100 sheets in a case that the sheet S has been left for ten days. Further, when the electrical discharging cloth is checked after 100 sheets passing, it is found that paper dust is adhered to the electrical discharging cloth, so the abnormal discharging image is occurred since the adhered paper dust may hinder the discharging effect.

### Second Embodiment

In the second embodiment, an experiment is conducted while the electrical discharging cloth is mounted and the distance between the electrical discharging cloth and the sheet S is set to be 5.1 mm. In the case of the second embodiment, the abnormal discharging image is occurred at a frequency of 2 out of 100 sheets in the case that the sheet S has been left for two days, and the abnormal discharging image is occurred at a frequency of 7 out of 100 sheets in the case that the sheet S has been left for ten days.

### Third Embodiment

In the third embodiment, an experiment is conducted while the electrical discharging cloth is mounted. In the third embodiment, the number of the abnormal discharging images is reduced. Specifically, in a case that the distance between the electrical discharging cloth and the sheet S is 5.0 mm and the sheet S has been left for two days, the abnormal discharging image is not occurred in any of 100 sheets. In the case that the sheet S has been left for ten days, the occurrence of the abnormal discharging image is reduced to a frequency of 5 out of 100 sheets.

### Modified Example 1

In a modified example 1, an experiment is conducted while the distance between the electrical discharging cloth and the sheet S is 4.0 mm. In the case of the modified example 1, the abnormal discharging image is not occurred in any of 100 sheets in the case that the sheet S has been left for two days, and the abnormal discharging image is occurred at a frequency of 5 out of 100 sheets in the case that the sheet S has been left for ten days. That is, the result is the same as that of the third embodiment which is described above.

### Modified Example 2

In a modified example 2, an experiment is conducted while the distance between the electrical discharging cloth and the sheet S is 3.0 mm. In the case of the modified example 2, the abnormal discharging image is not occurred in any of 100 sheets in the case that the sheet S has been left for two days, and the abnormal discharging image is occurred at a frequency of 4 out of 100 sheets in the case that the sheet S has been left for ten days. That is, in the case of the modified example 2, the occurrence of the abnormal discharging image is reduced in the case that the sheet S has been left for ten days.

### Modified Example 3

In a modified example 3, an experiment is conducted while the distance between the electrical discharging cloth and the sheet S is 1.9 mm. In the case of the modified example 3, the abnormal discharging image is not occurred in any of 100 sheets in the case that the sheet S has been left for two days, and the abnormal discharging image is occurred at a frequency of 2 out of 100 sheets in the case that the sheet S has been left for ten days. That is, in the case of the modified example 3, the occurrence of the abnormal discharging image is furthermore reduced in the case that the sheet S has been left for ten days.

### Modified Example 4

In a modified example 4, an experiment is conducted while the distance between the electrical discharging cloth and the sheet S is 1.8 mm. In the case of the modified example 4, the abnormal discharging image is not occurred in any of 100 sheets in the case that the sheet S has been left for two days, and the abnormal discharging image is not occurred in any of 100 sheets in the case that the sheet S has been left for ten days.

### Summary

According to the experimental results in Table 1, it is found that it is possible to suppress the frequency of the abnormal discharging image in all the cases from the first embodiment through the third embodiment in which the electrical discharging cloth is applied, compared to the comparative example in which the electrical discharging cloth is not applied. Further, it is found that it is possible to suppress the frequency of the abnormal discharging image in the second embodiment and the third embodiment in which the electrical discharging cloth and the sheet S are not contacted, compared to the first embodiment in which the electrical discharging cloth and the sheet S are contacted. Furthermore, it is found that it is possible to further suppress the frequency of the abnormal discharging image in the first embodiment in which the distance between the electrical discharging cloth and the sheet S is shorter than the second embodiment. That is, according to the results from the first embodiment through the third embodiment in Table 1, it is found that it is possible to obtain an effect to suppress the frequency of the abnormal discharging image by providing the electrical discharging cloth in a side upstream of the registration roller pair 4. Furthermore, it is found that it is possible to obtain the effect to further suppress the frequency of the abnormal discharging image by adjusting the distance (clearance) between the electrical discharging cloth and the sheet S. As shown in the result of the first embodiment, it is found that it is possible to obtain the effect to further suppress the frequency of the abnormal discharging image by setting the distance between the electrical discharging cloth and the sheet S to 1.8 mm to 5.0 mm.

Under a general use condition by a user, it is possible to suppress the frequency of the abnormal discharging image by maintaining a distance of 5.0 mm or less between the sheet S and the electrical discharging cloth. Further preferably, it is possible to prevent the occurrence of the abnormal discharging image even for paper which is dried to absolute dryness after leaving in a low-temperature, low-humidity environment for 10 days, as far as the sheet S and the electrical discharging cloth are kept at a distance of 1.8 mm or less without contact. When the electrical discharging cloth contacts the sheet S, a reduction of the discharging effect may be occurred by falling out of the fibrous bristle tip of the electrical discharging cloth and the adhesion of the paper dust from the sheet S, so it is not suitable for long term use. Therefore, it is preferable to use the electrical discharging member 60 in non-contact with the sheet S.

### Experiment 2 for Effect of Electrical Discharging Member, Comparison of Charge Amount of Sheet S

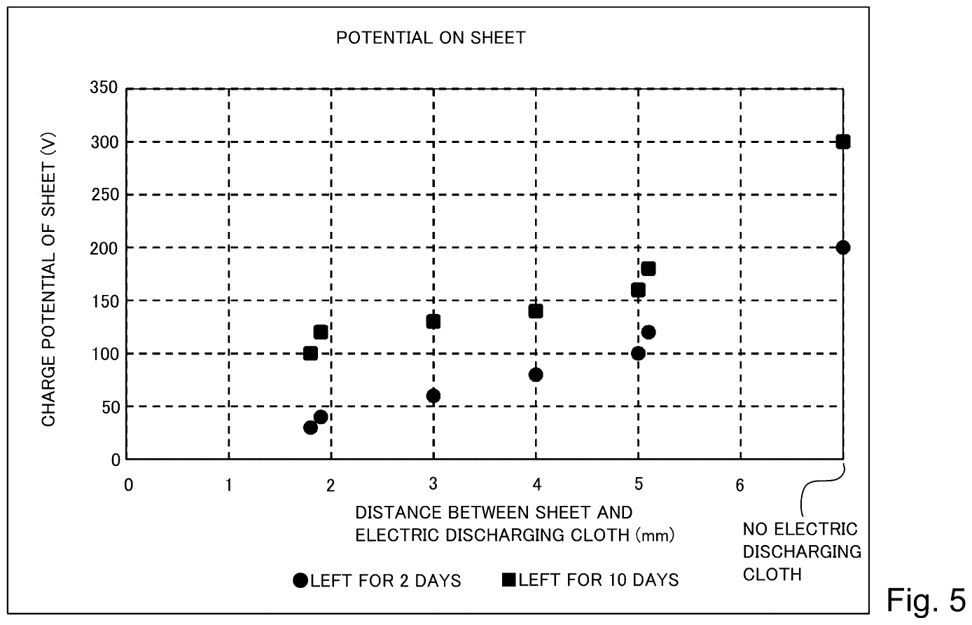

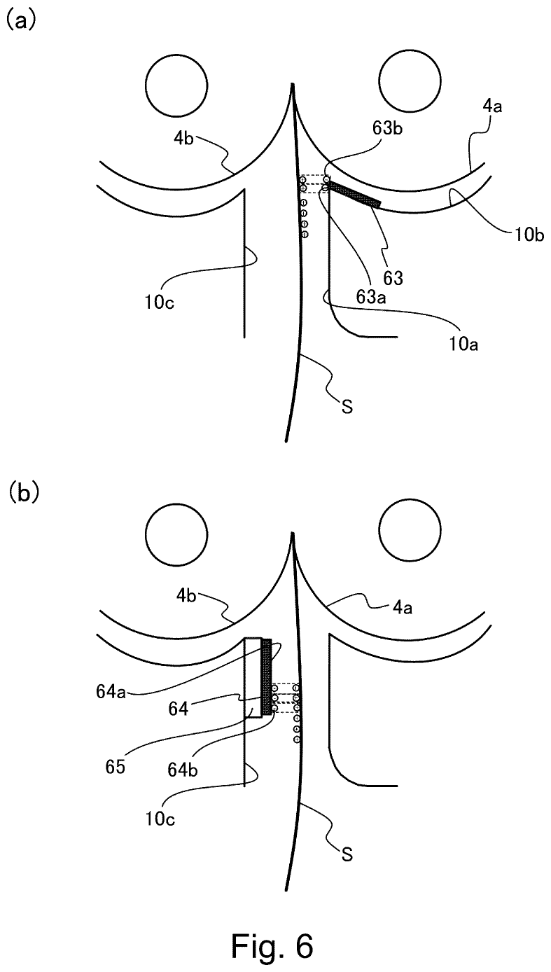

Next, a charge amount of each of the sheet S is measured. Under the same condition as the experiment 1, the printer 1 is urgently stopped and the sheet S is removed from the apparatus, after the leading end of the sheet S has been passed through the registration roller pair 4, and the charge amount of the sheet S is measured immediately before it is conveyed to the secondary transfer portion. The sheet S is in a state that it is mounted on an aluminum sheet of the registration roller 4a which is electrically grounded, and further in a state that it contacts the pickup roller 32a in the stacking tray 31. In the experiment 2, the charge amount on the sheet S at a position in which the pickup roller 32a is contacted is measured by a surface potential meter (surface potential meter Trek Model 344). Results are shown in FIG. 5. In FIG. 5, a horizontal axis indicates a distance (mm) between the sheet S and the electrical discharging cloth and a vertical axis indicates a charge potential (V) of the sheet S. Incidentally, the results of the comparative example without the electrical discharging cloth which is described above are indicated on a rightmost of the horizontal axis. Further, black circles indicate data for the sheet S which has been left for two days, while black squares indicate data for the sheet S which has been left for ten days.

Under a condition in which the electrical discharging cloth is not mounted as the comparative example, potentials on the sheet S which contacts the pickup roller 32a are +200V for the sheet S which has been left for two days and +300V for the sheet S which has been left for ten days. Further, the potentials on a portion of the sheet S which does not contact the pickup roller 32a are approximately +10V both for the sheet S which has been left for two days and for the sheet S which has been left for ten days.

On the other hand, when the electrical discharging cloth is mounted, the potential on the sheet S tends to be decreased as the distance between the sheet S and the electrical discharging cloth is reduced, as in the third embodiment and the modified examples from 1 thorough 4 which are described above. In a case that the distance between the sheet S and the electrical discharging cloth is 5.0 mm (the third embodiment), the potentials on the sheet S which contacts the pickup roller 32a are +100V for the sheet S which has been left for two days and +150V for the sheet S which has been left for ten days. Furthermore, when the distance between the electrical discharging cloth and the sheet S is reduced to 1.8 mm (the modified example 4), the potentials on the sheet S which contacts the pickup roller 32a are +30V for the sheet S which has been left for two days and +100V for the sheet S which has been left for ten days. This trend suggests that the longer the sheet S is left in the low-temperature, low-humidity environment, the more its moisture content decreases and its electric resistance increases, so the charge amount which is generated through friction with the pickup roller 32a is increased.

As described above, according to the results of the experiment 1 and the experiment 2, mechanisms for generating the abnormal discharging image are as follows:
(1) The sheet S which is fed and conveyed from the stacking tray 31 becomes positively charged due to a friction with the pickup roller 32a from a first sheet.
(2) When the sheet S enters the secondary transfer portion, a discharge occurs between the sheet S and the negatively charged toner image on the intermediate transfer belt 41.
(3) The halftone image is disturbed by the discharge.
(4) The abnormal image in which a portion of the toner image is missing is occurred within the halftone image.

For this reason, in the present disclosure, it is possible to discharge the sheet S which is charged with the positive polarity by mounting the electrical discharging cloth upstream of the registration roller pair 4 with respect to the conveyance direction Dt. Therefore, it is possible to suppress the discharge which is occurred between the toner image on the intermediate transfer belt 41 and the sheet S. Thus, it is possible to prevent a transfer defect and suppress the occurrence of the abnormal image.

According to the results of the experiments which are described above, it is possible to discharge the sheet S which is charged in the feeding portion and prevent the occurrence of the abnormal discharging image in the secondary transfer portion, by mounting the electrical discharging member 60 which does not contact the sheet S on the sheet conveyance guide 10a between the feeding portion and the registration roller pair 4. Furthermore, it is possible to reduce the charge amount of the sheet S, since the discharging effect is obtained more efficiently by reducing the distance between the electrical discharging member 60 and the sheet S.

In order to suppress an increase in a size of the main assembly as a feature of the printer 1 according to the third embodiment, the sheet conveyance guide is not provided between the secondary transfer portion and the registration roller pair 4 in the side downstream side of the registration roller pair 4 with respect to the conveyance direction Dt. Therefore, it is difficult to mount the electrical discharging cloth so that the distance between the sheet S and the electrical discharging cloth is set below a certain value while including from thin paper to thick paper. Further, when the electrical discharging cloth is close to the secondary transfer portion, good transfer quality may not be achieved by leaking the secondary transfer voltage via the electrical discharging cloth. In response to these issues, in the present disclosure, the electrical discharging member 60 is mounted between the feeding portion and the registration roller pair 4, so it is possible to stably discharge the sheet S which is charged in the feeding portion without increasing the size of the main assembly of the printer 1.

Incidentally, the distance between the electrical discharging member 60 and the sheet S for achieving the object is not limited to the values which are described above, however, it may be varied according to factors such as a fiber density of the electrical discharging cloth and a length of the bristle tip of the electrical discharging cloth. Further, specifically, the electrical discharging member 60 may be mounted between a feeding and conveying portion and the registration roller pair 4 so that the distance from the sheet S is less than or equal to than 5.0 mm.

### Modified Example 5

For example, as shown in part (a) of FIG. 6, the electrical discharging member 63 may be mounted in a position which is opposed to the registration roller 4a such as on a wall portion 10b. In this case, negative charges 63b are accumulated at a portion 63a, which is the closest to the sheet S, in the electrical discharging member 63. The portion 63a corresponds to at least a portion of the electrical discharging member 63 which is opposed to the sheet S.

Further, as shown in part (b) of FIG. 6, an electrical discharging member 64 may be mounted on a front surface side of the sheet S (a side to which the toner image is secondarily transferred). In other words, the electrical discharging member 64 may be mounted on a sheet conveyance guide 10c which is located on a side of the registration roller 4b. In this case, a supporting member 65 may be provided between the sheet conveyance guide 10c and the electrical discharging member 64 so that the distance between the electrical discharging member 64 and the sheet S is less than or equal to a predetermined distance such as 5 mm or less. In this case, negative charges 64b are accumulated at a portion 64a, which is the closest to the sheet S, in the electrical discharging member 64.

It is preferable that the electrical discharging members 60, 63, and 64 may be disposed in a non-contact manner from a durability point of view. Further, the electrical discharging member is electrically floating in the embodiments which are described above, however, it is not limited to this. That is, the electrical discharging member may be electrically grounded. It is possible to obtain higher discharging effect by grounding the electrical discharging member electrically. Whether or not to ground the electrical discharging member may be determined by considering a cost and a labor against the discharging effect.

In this way, an electrical discharging member for discharging a sheet is disposed between a feeding means and a registration roller pair in an image forming apparatus which does not include a conveyance guide for conveying the sheet between the registration roller pair and a secondary transfer roller. As a result, it is possible to discharge the sheet before being conveyed to the secondary transfer portion, and it is possible to prevent the occurrence of the abnormal discharge image. Further, since the sheet conveyance guide and the electrical discharging member are not provided between the registration roller pair and the secondary transfer portion, a space for those elements is not required, so it is possible to perform an excellent transfer without increasing a size of the main assembly.

As described above, according to the first embodiment, it is possible to perform the excellent transfer in the secondary transfer portion.

### Second Embodiment

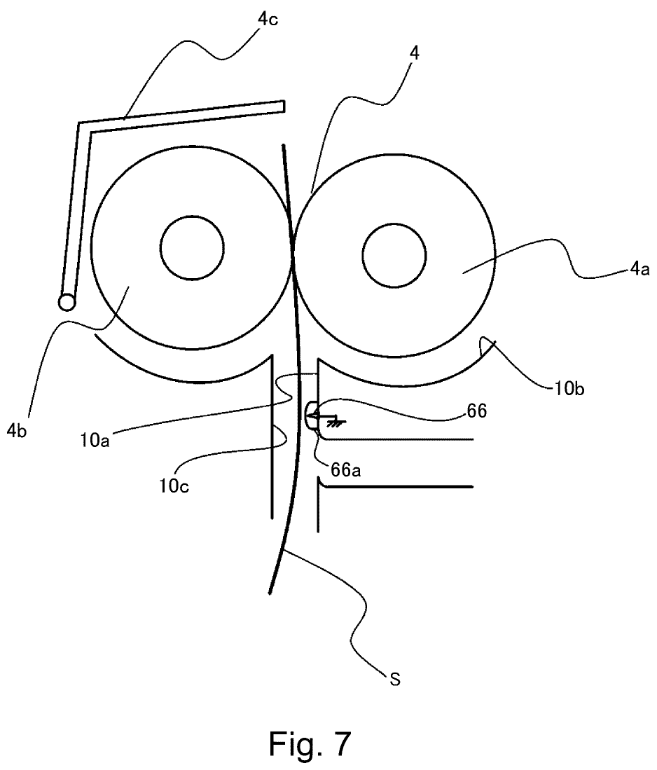

A configuration of the main assembly in the second embodiment is same as in the first embodiment, so specific descriptions regarding image formation will be omitted. As for disposing the electrical discharging member, as shown in FIG. 7, an electrical discharging needle 66 is disposed on the sheet conveyance guide 10a as an electrical discharging member. Further, the electrical discharging needle 66 is electrically grounded, as shown in FIG. 7. As for a shape of the electrical discharging needle 66, its height is 3 mm, its pitch is 2 mm, and its width is 100 mm in the longitudinal direction. Here, as for the electrical discharging needle 66, a plurality of needles are arranged in the direction of the rotational axis of the registration roller pair 4 and a distance between each needle is defined as the pitch as described above.

The electrical discharging needle 66 is made of stainless steel and its thickness is 0.1 mm. Incidentally, a rib 66a is provided with the electrical discharging needle 66 along the longitudinal direction (direction of rotational axis), and it is disposed so that the sheet S does not directly contact the electrical discharging needle 66. A distance between the sheet S and the electrical discharging needle 66 (more specifically, a leading end of the needle) is set to be 5.0 mm, similar to the first embodiment. Even with a configuration in which the electrical discharging needle 66 is disposed as such an electrical discharging member, it is possible to excellently discharge the sheet S which is positively charged, and it is possible to prevent the occurrence of the abnormal discharge image in the secondary transfer portion. This is because, similar to the electrical discharging cloth, the electrical discharging needle also generates corona discharge between the sheet S and a needle tip, and an electrical discharge is performed by coupling negative ions with positive charges on the sheet S. The electrical discharging needle 66 is electrically grounded and does not become charged, so it is possible to continuously exhibit the discharging effect. On the other hand, when the sheet S contacts the electrical discharging needle 66, breaking of the sheet or jamming of the sheet may be occurred, so it is preferable to mount the electrical discharging needle 66 in non-contact with the sheet S.

Further, other than the electrical discharging needle which is grounded, an charge neutralizer which generates ions to discharge may also be used. It is possible to excellently discharge the sheet S, which is positively charged, by disposing the charge neutralizer at the same position as the electrical discharging needle 66 and generating negative ions. Incidentally, the electrical discharging needle may be disposed on a side of the sheet conveyance guide 10c, as the electrical discharging member 64 which is shown in part (b) of FIG. 6. In this way, it is possible to discharge the sheet and prevent the occurrence of the abnormal discharging image, by providing the electrical discharging needle or the charge neutralizer in an upstream portion of the registration roller pair 4 in non-contact manner.

As described above, according to the second embodiment, it is possible to perform the excellent transfer in the secondary transfer portion.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-014186 filed on Jan. 30, 2025, which is hereby incorporated by reference herein in its entirety.

What is claimed is:

1. An image forming apparatus comprising:
an image bearing member on which a toner image is formed;
an intermediate transfer member on which the toner image formed on the image bearing member is transferred;
a transfer roller configured to form a transfer portion in contact with a surface of the intermediate transfer member and to transfer the toner image transferred on the intermediate transfer member in the transfer portion onto a sheet;
a first registration roller;
a second registration roller configured to nip the sheet with the first registration roller and to convey the sheet to the transfer portion;
a first accommodating portion configured to accommodate a sheet;
a second accommodating portion configured to accommodate a sheet in state of being exposed outside the image forming apparatus;
a feeding roller configured to form a feeding portion by contacting the sheet and feed the sheet from the first accommodating portion toward a contact portion formed by the first registration roller and the second registration roller in the feeding portion; and
an electrical discharging member configured to electrically discharge the sheet which is electrically charged,
wherein in a conveyance direction of the sheet, when a locus drawn by a leading end of the sheet is defined as a first conveyance passage in a case in the sheet is nipped and fed in the contact portion formed by the first registration roller and the second registration roller after the leading end of the sheet has passed through the feeding portion, and is nipped and fed in the transfer portion formed by the intermediate transfer member and the transfer roller after the leading end of the sheet has passed through the contact portion,
a locus drawn by a leading end of the sheet is defined as a second conveyance passage in a case in which the sheet accommodated in the second accommodating portion is fed toward the first registration roller and the second registration roller, and
a locus drawn by a leading end of the sheet is defined as a third conveyance passage in a case in which the sheet, of which a first surface on which image formation has been performed and a second surface, opposite to the first surface, on which the image formation is performed, is fed toward the first registration roller and the second registration roller,
the electrical discharging member
i) electrically discharges the sheet in between the contact portion and the feeding portion in the first conveyance passage, and
ii) is disposed upstream side of the contact portion and downstream side of the second conveyance passage and the third conveyance passage in the conveyance direction.

2. The image forming apparatus according to claim 1, wherein the electrical discharging member is disposed between the contact portion and the feeding portion in the first conveyance passage in the conveyance direction.

3. The image forming apparatus according to claim 1, further comprising no conveyance guide configured to guide the sheet in a region between the contact portion and the transfer portion in the first conveyance passage.

4. The image forming apparatus according to claim 1, wherein in the conveyance direction, a distance between the transfer portion and the contact portion is shorter than a distance between the contact portion and the feeding portion.

5. The image forming apparatus according to claim 1, wherein the first registration roller is disposed on the same side as the transfer roller with respect to the first conveyance passage.

6. The image forming apparatus according to claim 1, wherein at least a part of the electrical discharging member opposes the sheet which has been conveyed.

7. The image forming apparatus according to claim 1, wherein further comprising a conveyance guide configured to guide the sheet which has being conveyed and provided upstream of the first registration roller and the second registration roller in the conveyance direction.

8. The image forming apparatus according to claim 1, wherein the electrical discharging member is in non-contact with the sheet.

9. The image forming apparatus according to claim 1, wherein a shortest distance between the electrical discharging member and the sheet is 5.0 mm or less.

10. The image forming apparatus according to claim 1, wherein the electrical discharging member is electrically floating.

11. The image forming apparatus according to claim 1, wherein the electrical discharging member is electrically grounded.

12. The image forming apparatus according to claim 1, wherein the electrical discharging member is an electrical discharging cloth.

13. The image forming apparatus according to claim 1, wherein the electrical discharging member is electrical discharging needle.
